(19) United States
(12) Patent Application Publication
(10) Pub. No.: US 2025/0363393 A1
(43) Pub. Date: Nov. 27, 2025

(54) PROCESSING DEVICE, PROCESSING SYSTEM, PROCESSING METHOD, AND RECORDING MEDIUM

(71) Applicant: NEC Corporation, Minato-ku, Tokyo (JP)

(72) Inventors: Hisaya WAKAYAMA, Tokyo (JP); Tsutomu MARUYAMA, Tokyo (JP); Youko MORI, Tokyo (JP)

(73) Assignee: NEC Corporation, Minato-ku, Tokyo (JP)

(21) Appl. No.: 18/874,128

(22) PCT Filed: Jun. 24, 2022
(86) PCT No.: PCT/JP2022/025371

§ 371 Date: Dec. 12, 2024

(51) Int. Cl. G06N 5/022

(52) U.S. Cl. CPC G06N 5/022

(57) ABSTRACT

A calculator includes a memory configured to store instructions; and a processor configured to execute the instructions to: generate a predictive model for predicting a required work time of a task according to a combination of resources based on a combination of one or more types of tasks included in predetermined work and one or more skills required to execute the task, one or more types of resources for executing the predetermined work, a quantity of each of the resources, and a skill possessed by each of the resources; and identify the combination of the resources for completing the predetermined work based on the quantity of each of the tasks and the predictive model.

### TECHNICAL FIELD

The present disclosure relates to a processing device, a processing system, a processing method, and a recording medium.

### BACKGROUND ART

Robots are used in a variety of fields. For example, robots and humans may work together in fields of logistics and the like. Patent Document 1 discloses technology related to the allocation of a task to a worker and an automatic machine in a production line as the related art.

### PRIOR ART DOCUMENTS

### Patent Document

Patent Document 1: Japanese Unexamined Patent Application, First Publication No. 2021-163324

### SUMMARY

### Technical Problem

To accomplish a specific task, it is necessary to combine a plurality of resources with different skills. However, in the invention disclosed in Patent Document 1, it is not possible to identify a combination of a plurality of resources having different skills. Therefore, there is a need for technology to be able to identify an appropriate combination of resources for a predetermined task.

An objective of each example aspect of the present disclosure is to provide a processing device, a processing system, a processing method, and a recording medium capable of satisfying the above-described need.

### Solution to Problem

To achieve the above-described objective, according to an example aspect of the present disclosure, there is provided a processing device including: a first generation means configured to generate a predictive model for predicting a required work time of a task according to a combination of resources based on a combination of one or more types of tasks included in predetermined work and one or more skills required to execute the task, one or more types of resources for executing the predetermined work, a quantity of each of the resources, and a skill possessed by each of the resources; and an identification means configured to identify the combination of the resources for completing the predetermined work based on the quantity of each of the tasks and the predictive model.

To achieve the above-described objective, according to another example aspect of the present disclosure, there is provided a processing system including: the above-described processing device; and a robot configured to execute a process in accordance with control of the processing device.

To achieve the above-described objective, according to yet another example aspect of the present disclosure, there is provided a processing method including: generating a predictive model for predicting a required work time of a task according to a combination of resources based on a combination of one or more types of tasks included in predetermined work and one or more skills required to execute the task, one or more types of resources for executing the predetermined work, a quantity of each of the resources, and a skill possessed by each of the resources; and identifying the combination of the resources for completing the predetermined work based on the quantity of each of the tasks and the predictive model.

To achieve the above-described objective, according to yet another example aspect of the present disclosure, there is provided a recording medium storing a program for causing a computer to: generate a predictive model for predicting a required work time of a task according to a combination of resources based on a combination of one or more types of tasks included in predetermined work and one or more skills required to execute the task, one or more types of resources for executing the predetermined work, a quantity of each of the resources, and a skill possessed by each of the resources; and identify the combination of the resources for completing the predetermined work based on the quantity of each of the tasks and the predictive model.

### Advantageous Effects of Invention

According to each example aspect of the present disclosure, it is possible to identify an appropriate resource for predetermined work.

### BRIEF DESCRIPTION OF DRAWINGS

FIG. 1 is a diagram showing an example of a configuration of a processing system according to an example embodiment of the present disclosure.

FIG. 2 is a diagram showing an example of a configuration of a processing device according to an example embodiment of the present disclosure.

FIG. 3 is a diagram showing an example of task information in an example embodiment of the present disclosure.

FIG. 4 is a diagram showing an example of resource information in an example embodiment of the present disclosure.

FIG. 5 is a diagram showing an example of a predictive model generated by a first generation unit according to an example embodiment of the present disclosure.

FIG. 6 is a diagram showing an example of a processing flow of a processing system according to an example embodiment of the present disclosure.

FIG. 7 is a diagram showing an example of a processing device having a minimum configuration according to the example embodiment of the present disclosure.

FIG. 8 is a diagram showing an example of a processing flow of the processing device having a minimum configuration according to the example embodiment of the present disclosure.

FIG. 9 is a schematic block diagram showing a configuration of a computer according to at least one example embodiment.

### EXAMPLE EMBODIMENT

Hereinafter, example embodiments will be described in detail with reference to the drawings.

### Example Embodiment

A processing system 1 according to an example embodiment of the present disclosure is a system for identifying a combination of appropriate resources (i.e., robots and humans) for completing predetermined work in a short time in a case where a robot (e.g., a portable robot arm 20, a mobile robot arm 30, an automated guided vehicle (AGV) 40, and the like to be described below) and humans (e.g., workers A and B and the like to be described below) work together to perform the predetermined work. The processing system 1 is, for example, a system that is introduced into a warehouse of a logistics center and the like. The robot does not necessarily have to be a portable robot arm, but may be a stationary robot installed in a warehouse, a factory, or the like. The term “portable” refers to a resource that can be moved by other resources. The term “stationary” refers to a resource of which movement by other resources is difficult or a resource incapable of being moved by other resources.

In the example to be described below, an operation of the processing system 1 will be described with reference to an example in which the portable robot is a robot arm (specifically, a portable robot arm 20). However, it is only necessary to identify whether the robot is portable or stationary and the processing system 1 may include a portable robot arm and a stationary robot arm. Hereinafter, a robot arm that is portable is referred to as a “portable robot arm.”

### (Configuration of Processing System)

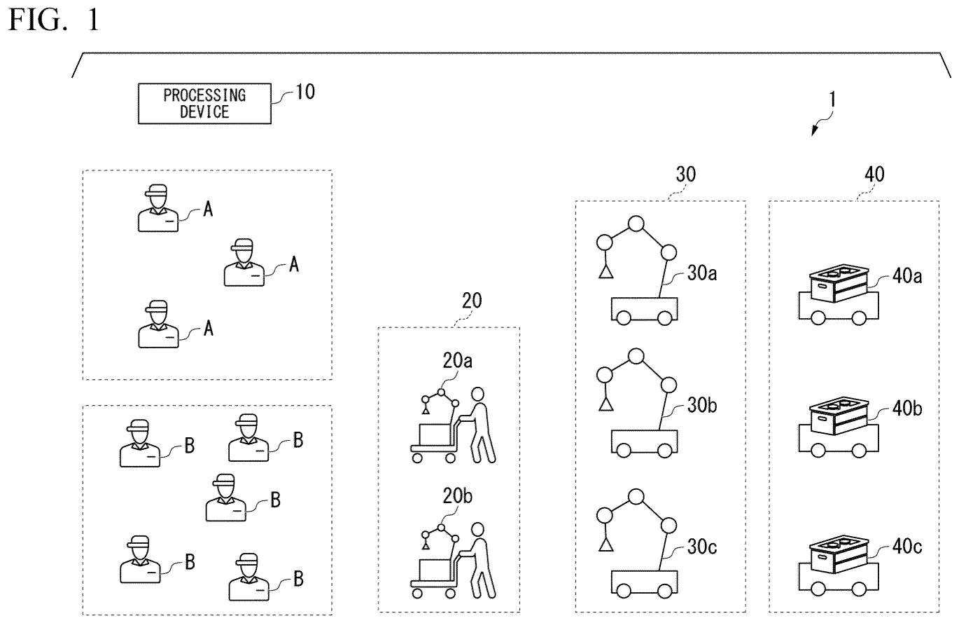

FIG. 1 is a diagram showing an example of a configuration of the processing system 1 according to an example embodiment of the present disclosure. As shown in FIG. 1, the processing system 1 includes a processing device 10, portable robot arms 20a and 20b (an example of a robot), mobile robot arms 30a, 30b, and 30c (an example of a robot), and AGVs 40a, 40b, and 40c (an example of a robot). Hereinafter, the portable robot arms 20a and 20b are collectively referred to as a portable robot arm 20. Moreover, the mobile robot arms 30a, 30b, and 30c are collectively referred to as a mobile robot arm 30. The mobile robot arm 30 represents an autonomously movable robot arm. Moreover, the AGVs 40a, 40b, and 40c are collectively referred to as an AGV 40. The processing system 1 may include a belt conveyor, a machining robot, and the like.

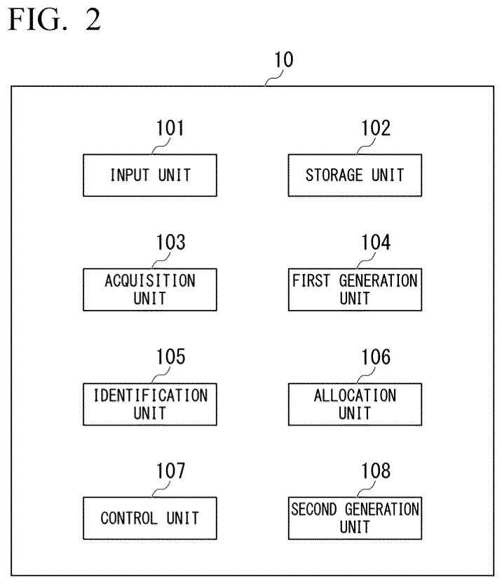

FIG. 2 is a diagram showing an example of a configuration of the processing device 10 according to an example embodiment of the present disclosure. As shown in FIG. 2, the processing device 10 includes an input unit 101, a storage unit 102, an acquisition unit 103, a first generation unit 104 (an example of a first generation means), an identification unit 105 (an example of an identification means), an allocation unit 106 (an example of an allocation means), a control unit 107 (an example of a control means), and a second generation unit 108 (an example of a second generation means).

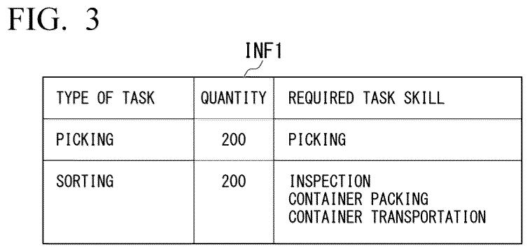

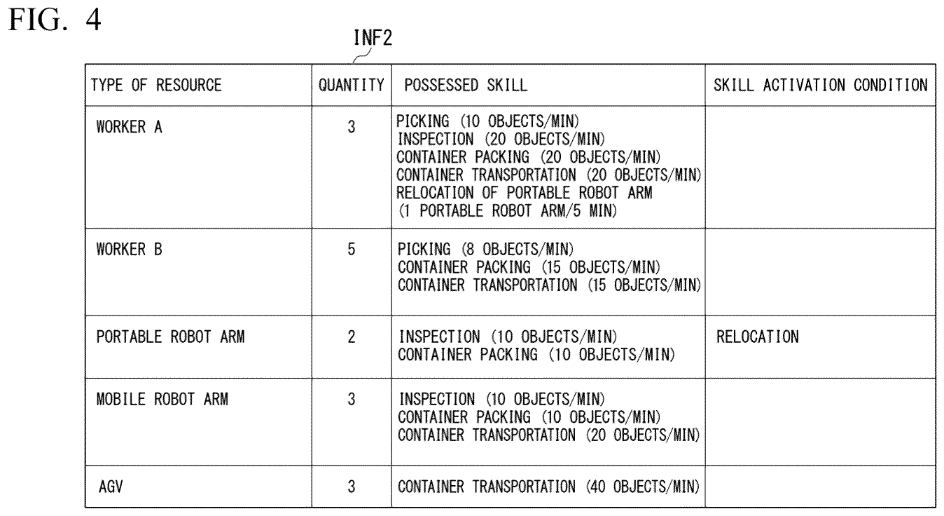

The input unit 101 receives inputs of task information INF1 (to be described below with reference to FIG. 3) and resource information INF2 (to be described below with reference to FIG. 4). The input unit 101 records the received task information INF1 and the received resource information INF2 in the storage unit 102. The task information INF1 is information including combinations of types of a plurality of tasks included in predetermined work, a quantity of each of the tasks, and a skill required for each of the tasks. Moreover, the resource information INF2 is information including combinations of types of a plurality of resources for executing predetermined work, a quantity of each of the plurality of resources, and a skill possessed by each of the plurality of resources. Although the plurality of tasks and the plurality of resources are described here, it is only necessary for each of the number of tasks and the number of resources to be one or more in the example embodiments of the present disclosure.

FIG. 3 is a diagram showing an example of the task information INF1 in an example embodiment of the present disclosure. The task information INF1 is information including a type of task included in predetermined work, a quantity of each task, and a skill required to execute each task (referred to as a required task skill in FIG. 3). That is, the task information INF1 is information including content of the predetermined work, a work quantity, and a required skill. In the example shown in FIG. 3, types of a plurality of tasks included in the predetermined work include picking and sorting. Moreover, the quantities of each of the plurality of tasks include 200 for picking and 200 for sorting. Moreover, as a skill required for each of the plurality of tasks, a picking skill is included in the picking. Skills of inspection, container packing, and container transportation are included in the sorting.

FIG. 4 is a diagram showing an example of the resource information INF2 in an example embodiment of the present disclosure. The resource information INF2 is information including a type of resource capable of being allocated to predetermined work, a quantity of each resource, a skill possessed by each resource (described as a possessed skill in FIG. 4), and a skill activation condition. The skill includes information indicating a quantity of work that can be implemented within a predetermined time. In the example shown in FIG. 4, worker A, worker B, the portable robot arm 20, the mobile robot arm 30, and the AGV 40 are included as types of a plurality of resources for executing the predetermined work. Moreover, worker A is responsible for picking (10 objects/min), inspection (20 objects/min), container packing (20 objects/min), container transportation (20 objects/min), and relocation of a portable robot arm (1 portable robot arm/5 min) as skills possessed by each of the plurality of resources. Worker B is responsible for picking (8 objects/min), container packing (15 objects/min), and container transportation (15 objects/min). The portable robot arm 20 is responsible for inspection (10 objects/min) and container packing (10 objects/min). The mobile robot arm 30 is responsible for inspection (10 objects/min), container packing (10 objects/min), and container transportation (20 objects/min). The AGV 40 is responsible for container transportation (40 objects/min). Moreover, the quantities of each of the plurality of resources include 3 workers A, 5 workers B, 2 portable robot arms 20, 3 mobile robot arms 30, and 3 AGVs 40.

For example, worker A's skill “picking (10 objects/min)” indicates that worker A can pick 10 objects (e.g., products, goods, or goods-in-process) per minute. Worker A's skill “relocation of a portable robot arm (1 portable robot arm/5 min)” indicates that it takes 5 min for worker A to move and install one portable robot arm 20. The skill “container packing (10 objects/min)” of the portable robot arm 20 indicates that the portable robot arm 20 can pack 10 objects into a container per minute. The AGV 40's skill “container transportation (40 objects/min)” indicates that AGV 40 can transport 40 objects in a container per minute.

Moreover, the input unit 101 receives constraint conditions. The input unit 101 records the received constraint conditions in the storage unit 102. Examples of the constraint conditions include an entry prohibition area in a case where predetermined work is executed, an area deviating from a movable range of each of the portable robot arm 20, the mobile robot arm 30, and the AGV 40, further conditions for a face of a target object in a case where each of the portable robot arm 20 and the mobile robot arm 30 grasps the target object for work, release the grasp of the target object, and a switching of the target object from one robot arm to another robot arm, and the like. In addition, in each example embodiment of the present disclosure, a “grasp” includes “adsorption” in which the target object is suctioned by a vacuum or the like and a “pinch” in which a physical object is pinched by two or more pseudo-fingers resembling fingers of a human or animal.

The storage unit 102 stores the task information INF1 and the resource information INF2. Moreover, the storage unit 102 stores the constraint conditions.

The acquisition unit 103 acquires the task information INF1 and the resource information INF2. For example, the acquisition unit 103 reads the task information INF1 and the resource information INF2 stored by the storage unit 102. Moreover, for example, the acquisition unit 103 may directly acquire the task information INF1 and the resource information INF2 received by the input unit 101 from the input unit 101.

Moreover, the acquisition unit 103 acquires the constraint conditions. For example, the acquisition unit 103 reads the constraint conditions stored by the storage unit 102. Moreover, for example, the acquisition unit 103 may directly acquire the constraint conditions received by the input unit 101 from the input unit 101.

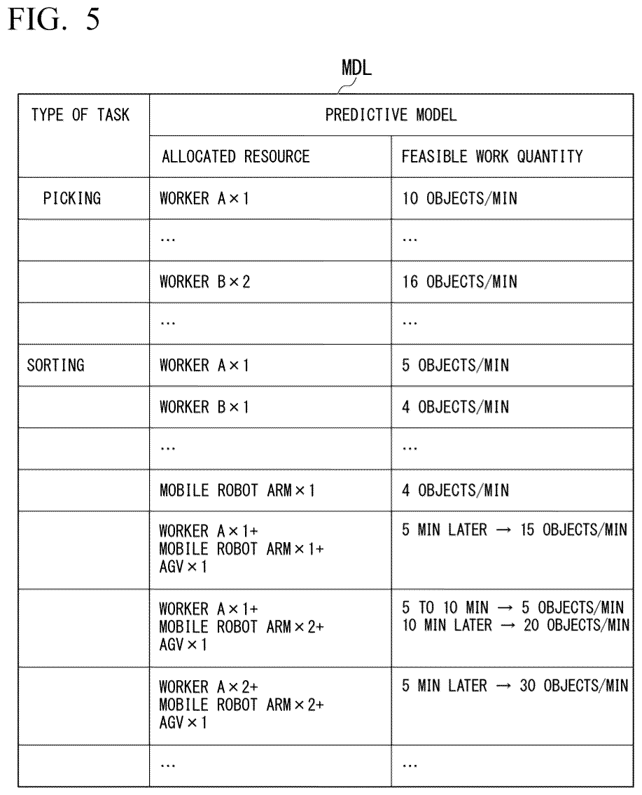

The first generation unit 104 generates a predictive model MDL (to be described with reference to FIG. 5) for predicting a work time for each combination of resources included in a plurality of resources based on information indicating a type of task included in predetermined work and a skill necessary to execute each task included in the task information INF1 and a type of resource capable of being allocated to predetermined work and, a quantity of each resource, a skill possessed by each resource, and a skill activation condition included in the resource information INF2. For example, the first generation unit 104 generates the predictive model MDL for predicting work time for each combination of resources included in a plurality of resources based on the task information INF1 and the resource information INF2 acquired by the acquisition unit 103.

Specifically, the first generation unit 104 generates the predictive model MDL as follows. The first generation unit 104 identifies a type of each task in the task information INF1 acquired by the acquisition unit 103. The first generation unit 104 identifies a quantity and a necessary skill for each identified task in the task information INF1. For example, in a case where the task information INF1 is the task information INF1 shown in FIG. 3, the first generation unit 104 identifies picking and sorting as task types. Also, the first generation unit 104 identifies that the quantity is 200 and the required skill is picking for the picking task. Moreover, the first generation unit 104 identifies that the quantity is 200 and the required skills are inspection, container packing, and container transportation for the sorting task. In addition, at this stage, the first generation unit 104 has identified the content of the predetermined work, the work quantity, and the necessary skills.

Subsequently, the first generation unit 104 identifies types and quantities of resources capable of being allocated to each identified task based on the identified necessary skills. For example, in a case where the identified task is picking, the first generation unit 104 identifies types and quantities of resources for which the possessed skill is picking in the resource information INF2 acquired by the acquisition unit 103 (workers A (3 workers) and workers B (5 workers) in a case where the resource information INF2 is the resource information INF2 shown in FIG. 4). Moreover, for example, in a case where the identified task is sorting, the first generation unit 104 identifies types and quantities of resources for which the possessed skill is inspection, container packing, or container transportation in the resource information INF2 acquired by the acquisition unit 103 (workers A (3 workers), workers B (5 workers), portable robot arms 20 (2 portable robot arms), mobile robot arms 30 (3 mobile robot arms), and AGVs 40 (3 AGVs) in the case of the resource information INF2 shown in FIG. 4). Moreover, for example, the first generation unit 104 determines whether or not there is a skill activation condition in the resource information INF2 acquired by the acquisition unit 103. In a case where it is determined that there is no skill activation condition, the first generation unit 104 ends a process of identifying the types and quantities of resources. Moreover, in a case where it is determined that there is a skill activation condition, the first generation unit 104 identifies types and quantities of resources having the skill activation condition and types and quantities of resources having the skill satisfying the activation condition. For example, in the case of the resource information INF2 shown in FIG. 4, the first generation unit 104 identifies the portable robot arms 20 (3 portable robot arms) as resources having the skill activation condition because “relocation” is included in the skill activation condition with respect to the portable robot arm 20. Furthermore, from the resource information INF2, because the skills possessed by workers A include “relocation of a portable robot arm,” workers A (3 workers) are identified as the type and quantity of resources having a skill for satisfying the skill activation condition of the portable robot arm. At this stage, the first generation unit 104 has completed a process of identifying types and quantities of resources capable of being allocated to each task in the predetermined work.

Subsequently, the first generation unit 104 identifies all combinations of types and quantities of resources capable of being allocated for each task in predetermined work. For example, in a case where the resource information INF1 is the resource information INF1 shown in FIG. 3 and the resource information INF2 is the resource information INF2 shown in FIG. 4, because workers A (3 workers) and workers B (5 workers) can be allocated to the picking task, the first generation unit 104 identifies all combinations of workers A (3 workers) and workers B (5 workers), i.e., “worker A (1 worker),” “worker A (1 worker) and worker B (1 worker),” “worker A (1 worker) and workers B (2 workers),” “worker A (1 worker) and workers B (3 workers),” “worker A (1 worker) and workers B (4 workers),” “worker A (1 worker) and workers B (5 workers),” “workers A (2 workers),” “workers A (2 workers) and worker B (1 worker),” “workers A (2 workers) and workers B (2 workers),” workers A (2 workers) and workers B (3 workers),” “workers A (2 workers) and workers B (4 workers),” “workers A (2 workers) and workers B (5 workers),” “workers A (3 workers),” “workers A (3 workers) and worker B (1 worker),” “workers A (3 workers) and workers B (2 workers),” “workers A (3 workers) and workers B (3 workers),” “workers A (3 workers) and workers B (4 workers),” and “workers A (3 workers) and workers B (5 workers).” Moreover, for example, in a case where the resource information INF1 is the resource information INF1 shown in FIG. 3 and the resource information INF2 is the resource information INF2 shown in FIG. 4, because workers A (3 workers), workers B (5 workers), portable robot arms 20 (2 portable robot arms), mobile robot arms 30 (3 mobile robot arms), and AGVs 40 (3 AGVs) can be allocated to the sorting task, the first generation unit 104 identifies all combinations of workers A (3 workers), workers B (5 workers), portable robot arms 20 (2 portable robot arms), mobile robot arms 30 (3 mobile robot arms), and AGVs 40 (3 AGVs).

Subsequently, the first generation unit 104 calculates a feasible work quantity for each of the identified all combinations of the types and quantities of resources using the skills possessed by each resource in the resource information INF2.

For example, in a case where the resource information INF2 is the resource information INF2 shown in FIG. 4 and worker A (1 worker) is allocated to the picking task, the first generation unit 104 calculates 10 objects per minute as a feasible work quantity. Moreover, for example, in a case where the resource information INF2 is the resource information INF2 shown in FIG. 4 and worker A (1 worker), a portable robot arm 20 (1 portable robot arm), and an AGV 40 (1 AGV) are allocated to the sorting task, the first generation unit 104 calculates 15 objects per minute as a feasible work quantity from 5 min later. Also, for each task, the first generation unit 104 combines the resources allocated to the task and the calculated feasible work quantity for the resources. A combination of the allocated resources for each task and the calculated feasible work quantity for the resources is the predictive model MDL.

In addition, the first generation unit 104 may acquire alternative information from the input unit 101 or the storage unit 102 instead of at least one item of the task information INF1 and the resource information INF2 acquired by the acquisition unit 103 and generate a predictive model MDL for predicting a work time for each combination of resources included in a plurality of resources.

FIG. 5 is a diagram showing an example of the predictive model MDL generated by the first generation unit 104 according to an example embodiment of the present disclosure. In the example shown in FIG. 5, the resource information INF1 is the resource information INF1 shown in FIG. 3 and the resource information INF2 is the resource information INF2 shown in FIG. 4. For each type of task, a predictive model MDL indicating a quantity of work per unit time capable of predicting a work time is shown for each combination of resources to be allocated. Therefore, the type of task shown in FIG. 5 is the same as the type of task shown in FIG. 3. Moreover, the allocated resources shown in FIG. 5 are all combinations of resources holding the skills required for each task shown in FIG. 4. In addition, in the example shown in FIG. 5, not all combinations of resources allocated to each of picking and sorting are shown and only some combinations of resources are shown. According to the predictive model MDL shown in FIG. 5, in a case where two workers B are allocated to the picking work, the feasible work quantity is 16 objects per minute. Moreover, according to the predictive model MDL shown in FIG. 5, in a case where one worker A, one portable robot arm 20, and one AGV 40 are allocated to the sorting work, if the relocation of the portable robot arm 20 is completed by worker A after 5 min, worker A and the portable robot arm 20 are in charge of inspection and container packing, and the AGV 40 is in charge of container transportation, such that the feasible work quantity is 15 objects per minute. Moreover, according to the predictive model MDL shown in FIG. 5, in a case where one worker A, two portable robot arms 20, and one AGV 40 are allocated to the sorting work, the feasible work quantity is 5 objects per minute for 5 to 10 min and 20 objects per minute after 10 min. That is, during a period of 0 to 5 min, worker A relocates the first portable robot arm 20, and the predicted feasible work quantity is 0. During a period of 5 to 10 min, the first portable robot arm 20 is in charge of inspection and container packing in parallel with a process in which worker A relocates the second portable robot arm 20 and the AGV 40 is in charge of container transportation, such that the predicted feasible work quantity is 5 objects per minute. Also, after the elapse of 10 min, worker A and two portable robot arms 20 are in charge of inspection and container packing and the AGV 40 is in charge of container transportation, such that the predicted feasible work quantity is 20 objects per minute.

Alternatively, the above-described operation may be the following operation. It is assumed that the task is “sorting.” In this case, the first generation unit 104 identifies the skill “inspection,” the skill “container packing,” and the skill “container transportation” for the task “sorting” based on the task information INF1 (exemplified in FIG. 3). The first generation unit 104 identifies the type and quantity of resources having the skill “inspection” based on the resource information INF2. In the resource information INF2 (exemplified in FIG. 4), three workers A, two portable robot arms 20, and three mobile robot arms 30 have the skill “inspection.” Therefore, the first generation unit 104 identifies three workers A, two portable robot arms 20, and three mobile robot arms 30 for the task “inspection.”

Likewise, for the skill “container packing,” the first generation unit 104 identifies three workers A, five workers B, two portable robot arms 20, and three mobile robot arms 30 based on the resource information INF2 (exemplified in FIG. 4). Moreover, for the skill “container transportation,” the first generation unit 104 identifies three workers A, five workers B, three mobile robot arms 30, and three AGVs 40.

Moreover, for the task “picking,” the first generation unit 104 identifies the skill “picking” based on the task information INF1 (exemplified in FIG. 3). Also, for the skill “picking,” the first generation unit 104 identifies three workers A and five workers B based on the resource information INF2 (exemplified in FIG. 4).

Also, the first generation unit 104 determines whether or not there is a resource having an activation condition in the resource information INF2 acquired by the acquisition unit 103. In a case where the first generation unit 104 determines that there is no resource having the activation condition, the first generation unit 104 ends a process of identifying types and quantities of resources. Moreover, in a case where it is determined that there is a resource having an activation condition, the first generation unit 104 identifies a resource having an activation condition and a resource type and quantity satisfying the condition. For example, the first generation unit 104 identifies that the three portable robot arms 20 have a skill activation condition “relocation” in the identified resource type and quantity and identifies that three workers A have a skill “relocation of a portable robot arm” satisfying the skill activation condition in the resource information INF2.

In the case of the example shown here, the first generation unit 104 identifies the following combinations as a combination of the type and quantity of resources capable of implementing the task “picking.”

The combinations are “worker A (1 worker),” “worker A (1 worker) and worker B (1 worker),” “worker A (1 worker) and workers B (2 workers),” “worker A (1 worker) and workers B (3 workers),” “worker A (1 worker) and workers B (4 workers),” “worker A (1 worker) and workers B (5 workers),” “workers A (2 workers),” “workers A (2 workers) and worker B (1 worker),” “workers A (2 workers) and workers B (2 workers),” “workers A (2 workers) and workers B (3 workers),” “workers A (2 workers) and workers B (4 workers),” “workers A (2 workers) and workers B (5 workers),” “workers A (3 workers),” “workers A (3 workers), and worker B (1 worker),” “workers A (3 workers) and workers B (2 workers),” “workers A (3 workers) and workers B (3 workers),” “workers A (3 workers) and workers B (4 workers),” and “workers A (3 workers) and workers B (5 workers).”

For each required task skill identified for the task “sorting,” the first generation unit 104 executes a process similar to the above-described process. For example, the skill “inspection,” the skill “container packing,” and the skill “container transportation” are all possessed by worker A. That is, worker A can implement the task “sorting.” Therefore, the first generation unit 104 identifies the following combination in which the number of workers A is “3” or less.

The following combination is “worker A (1 worker),” “workers A (2 workers),” or “workers A (3 workers).”

Moreover, the task “sorting” can be implemented even if worker A performs the skill “inspection,” the portable robot arm 20 performs the skill “container packing,” and the AGV 40 performs the skill “container transportation.” The first generation unit 104 determines whether or not the portable robot arm 20 is included in resources for implementing the task “sorting.” In a case where it is determined that the resources include the portable robot arm 20, the first generation unit 104 identifies the resource having the skill “relocation of the portable robot arm.” In a case where the identified resource is worker A, the resource “worker A,” the resource “portable robot arm 20,” and the resource “AGV 40” are identified as allocated resources. Also, the first generation unit 104 calculates 10 objects/min (=20 objects/(1+1) min) that is the feasible work quantity in a case where worker A relocates the portable robot arm 20 for a required time (5 min) and worker A performs inspection and container packing as the feasible work quantity of the task. Moreover, the first generation unit 104 calculates 5 objects/min (=10 objects/(1+1) min) as the feasible work quantity in a case where the portable robot arm 20 performs inspection and container packing. Also, the first generation unit 104 calculates 15 (=10+5) objects/min as the feasible work quantity after 5 min in a case where the task “sorting” is implemented using the above resources. Furthermore, the first generation unit 104 calculates 20 objects/min as the feasible work quantity in a case where one AGV 40 performs the skill “container transportation.” Therefore, the first generation unit 104 calculates 15 (=10+5) objects/min as the feasible work quantity of the task “sorting” after 5 min. In other words, in this example, the first generation unit 104 calculates a predictive model so that the relocated portable robot arm 20 starts the skill “inspection” and the skill “container transportation” immediately after worker A relocates the portable robot arm 20.

Likewise, in a case where there are one worker A, two portable robot arms 20, and one AGV, the first generation unit 104 calculates 5 min as the time for worker A to transport one portable robot arm 20. Moreover, the first generation unit 104 calculates 5 objects/min (=10 objects/(1+1) min) as the feasible work quantity in a case where one portable robot arm 20 has performed the skill “inspection” and the skill “container transportation” after 5 min. Moreover, the first generation unit 104 further calculates 5 min as the time for transporting the second portable robot arm 20 and calculates 10 objects/min (=(5+5) objects/min) as the feasible work quantity in a case where two portable robot arms 20 have performed the skill “inspection” and the skill “container transportation” after 10 min. Also, the first generation unit 104 calculates 10 objects/min (=20 objects/(1+1) min) as the feasible work quantity in a case where worker A has performed the skill “inspection” and the skill “container transportation” after 10 min and calculates 20 objects/min as the feasible work quantity in a case where the AGV 40 has performed the skill “container transportation.” Therefore, the first generation unit 104 calculates 5 objects/min between 5 min and 10 min and 20 (=10+10) objects/min after 10 min as the feasible work quantity of the task “sorting.” In other words, in this example, the first generation unit 104 calculates a predictive model so that the relocated portable robot arm 20 starts the skill “inspection” and the skill “container transportation” immediately after worker A relocates the portable robot arm 20.

The identification unit 105 identifies a combination of resources included in a plurality of resources for completing predetermined work in the shortest work time based on a quantity of each of the plurality of tasks included in the task information INF1 and the predictive model MDL generated by the first generation unit 104. Specifically, the identification unit 105 derives an optimal solution for each of predictive models MDL generated by the first generation unit 104, for example, by solving the following integer programming problem.

$${min}_{j} {max}_{i} {N}_{i} / {E}_{i} ( {R}_{i , j} ) \qquad [ Math . 1 ]$$

$$s . t . {R}_{i , j} = \{ {R}_{i , j , k} \} for k in 1 , ... , K and$$

$${\sum }_{i} {R}_{i , j , k} \leq {R}_{k} for selected j and k in 1 , ... , K$$

Here, Ni denotes a total quantity of task i, R_{i,j} denotes a j^{th} candidate for the resource allocated to task i, Eᵢ(R_{i,j}) denotes a feasible work quantity in a case where resources R_{i,j} are allocated to task i, R_{i,j,k} denotes a quantity of a resource k included in the allocated resources R_{i,j}, and Rₖ denotes a total quantity of the resource k. That is, an optimization problem in which allocated resources are variables, a constraint condition is that a sum of allocated resources does not exceed a total quantity of resources in each resource type, and the minimization of a maximum value of time until the task is completed is designated as an objective function is solved. In addition, the constraint condition and the objective function are not limited to those shown above. For example, in a case where a required time for completing a task is given, the task completion within the required time is designated as a constraint condition in addition to a condition that a sum of allocated resources in each resource type does not exceed a total quantity of resources, and the minimization of a sum of allocated specific resources (for example, workers) may be designated as an objective function. Examples of the method of solving the integer programming problem as described above include an exact solution method of obtaining the best solution or an exact solution among all combinations by trying all the combinations, a dynamic programming method of efficiently obtaining an exact solution by sequentially updating a table without trying all the combinations, a branch limitation method of relaxing the integer programming problem to a linear programming problem and introducing the concept of a continuous relaxation problem to obtain an exact solution, and the like. In other words, the identification unit 105 identifies a combination of resources necessary to perform a predetermined task using the predictive model MDL generated by the first generation unit 104. In addition, a method by which the identification unit 105 identifies a combination of resources is not limited to the above-described example.

In addition, in a case where the identification unit 105 identifies the combination of resources using a dynamic programming method of trying only a limited combination, a branch limitation method, or the like instead of an exact solution method of trying all the combinations, a process in which the first generation unit 104 generates the predictive model MDL and a process in which the identification unit 105 identifies a combination of resources are performed in parallel instead of a process in which the identification unit 105 identifies a combination of resources with respect to each of the predictive models MDL generated by the first generation unit 104 after the first generation unit 104 generates all the predictive models MDL, such that the first generation unit 104 does not need to generate an ineffective predictive model MDL.

The allocation unit 106 allocates a combination of resources identified by the identification unit 105 to predetermined work.

The second generation unit 108 generates an operation plan (an example of a plan) based on the resources allocated by the allocation unit 106. The operation plan is a plan indicating a flow of an operation of a non-human resource (i.e., a robot and each of a portable robot arm 20, a mobile robot arm 30, and an AGV 40 included in the resources allocated by the allocation unit 106 in the example embodiment of the present disclosure).

For example, in a case where the allocation unit 106 allocates a resource in which one portable robot arm 20, one mobile robot arm 30, and one AGV 40 are combined as a resource for executing predetermined work, the second generation unit 108 generates an operation plan for executing work in a range in which a constraint condition is satisfied with each of the one portable robot arm 20, the one mobile robot arm 30, and the one AGV 40. Moreover, for example, in a case where the allocation unit 106 allocates a resource in which one portable robot arm 20 and two AGVs 40 are combined as a resource for executing predetermined work, the second generation unit 108 generates an operation plan for executing work in a range in which a constraint condition is satisfied with each of the one portable robot arm 20 and the two AGVs 40. At this time, the second generation unit 108 may be configured to generate a plan verified as an executable operation plan using a simulation. Alternatively, the second generation unit 108 may be configured to perform a generation process by formulating each executable operation plan as task and motion planning (TAMP) and solving the formulated plan.

In addition, the second generation unit 108 may acquire constraint information directly from the input unit 101 or the storage unit 102 instead of constraint information acquired by the acquisition unit 103 and generate an operation plan (an example of a plan) based on the resources allocated by the allocation unit 106.

The control unit 107 controls a robot (i.e., each of a portable robot arm 20, a mobile robot arm 30, and an AGV 40) included in the resources of the combination identified by the identification unit 105. For example, the control unit 107 generates a control signal for controlling the robot based on the operation plan generated by the second generation unit 108. Also, the control unit 107 outputs the generated control signal to the robot.

The portable robot arm 20 is a robot capable of being relocated by a human. The portable robot arm 20 includes one or more arms capable of grasping a physical object serving as a work target. The portable robot arm 20 can execute inspection and container packing work, for example, in response to a control signal generated by the processing device 10.

The mobile robot arm 30 is a movable robot in response to a control signal generated by the processing device 10. The mobile robot arm 30 includes one or more arms capable of grasping a target object serving as a work target. The mobile robot arm 30 can execute inspection, container packing, and container transportation work, for example, in response to the control signal generated by the processing device 10.

The AGV 40 is a robot capable of autonomous driving. The AGV 40 is a robot capable of transporting a target object serving as a work target in response to a control signal generated by the processing device 10. The AGV 40 can execute container transportation work, for example, in response to a control signal generated by the processing device 10.

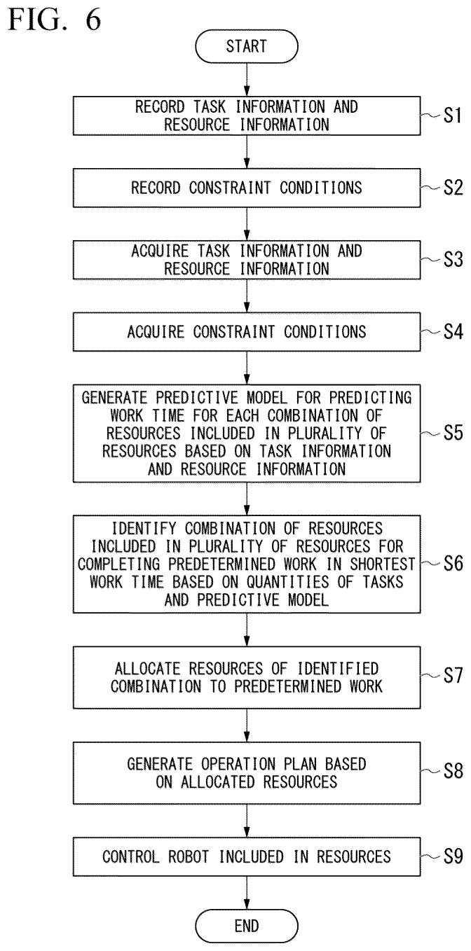

FIG. 6 is a diagram showing an example of a processing flow of the processing system 1 according to an example embodiment of the present disclosure. Next, details of the process performed by the processing device 10 of the processing system 1 will be described with reference to FIG. 6.

The input unit 101 receives the inputs of the task information INF1 and the resource information INF2. The input unit 101 records the received task information INF1 and the received resource information INF2 in the storage unit 102 (step S1).

Moreover, the input unit 101 receives constraint conditions. The input unit 101 records the received constraint conditions in the storage unit 102 (step S2).

The storage unit 102 stores the task information INF1 and the resource information INF2. Moreover, the storage unit 102 stores the constraint conditions.

The acquisition unit 103 acquires the task information INF1 and the resource information INF2 (step S3). For example, the acquisition unit 103 reads the task information INF1 and the resource information INF2 stored by the storage unit 102. Moreover, for example, the acquisition unit 103 may directly acquire the task information INF1 and the resource information INF2 received by the input unit 101 from the input unit 101.

Moreover, the acquisition unit 103 acquires constraint conditions (step S4). For example, the acquisition unit 103 reads the constraint conditions stored by the storage unit 102. Moreover, for example, the acquisition unit 103 may directly acquire the constraint conditions received by the input unit 101 from the input unit 101.

Next, the first generation unit 104 generates a predictive model MDL for predicting a work time for each combination of resources included in a plurality of resources based on information indicating a type of task included in predetermined work and a skill necessary to execute each task included in the task information INF1 and a type of resource capable of being allocated to predetermined work, a quantity of each resource, a skill possessed by each resource, and a skill activation condition included in the resource information INF2 (step S5). For example, the first generation unit 104 generates a predictive model MDL for predicting a work time for each combination of resources included in a plurality of resources based on the task information INF1 and the resource information INF2 acquired by the acquisition unit 103. In addition, the first generation unit 104 may acquire alternative information from the input unit 101 or the storage unit 102 instead of at least one item of the task information INF1 and the resource information INF2 acquired by the acquisition unit 103 and generate a predictive model MDL for predicting a work time for each combination of resources included in the plurality of resources.

The identification unit 105 identifies a combination of resources included in a plurality of resources for completing predetermined work, for example, in the shortest work time, based on the quantity of each of the plurality of tasks included in the predetermined work included in the task information INF1 and the predictive model MDL generated by the first generation unit 104 (step S6). Specifically, the identification unit 105 identifies a combination of resources for completing predetermined work in the shortest work time, for example, by solving an integer programming problem in which allocated resources are variables, a constraint condition is that a sum of allocated resources does not exceed a total quantity of resources in each resource type, and the minimization of a maximum value of time until the task is completed is designated as an objective function, with respect to each of the predictive models MDL generated by the first generation unit 104.

The allocation unit 106 allocates resources of the combination identified by the identification unit 105 to predetermined work (step S7).

The second generation unit 108 generates an operation plan based on the resources allocated by the allocation unit 106 (step S8). At this time, the operation plan may be further generated based on constraint conditions.

For example, in a case where the allocation unit 106 allocates a resource in which one portable robot arm 20, one mobile robot arm 30, and one AGV 40 are combined as a resource for executing predetermined work, the second generation unit 108 generates an operation plan for executing work in a range in which a constraint condition is satisfied with each of the one portable robot arm 20, the one mobile robot arm 30, and the one AGV 40. Moreover, for example, in a case where the allocation unit 106 allocates a resource in which one portable robot arm 20 and two AGVs 40 are combined as a resource for executing predetermined work, the second generation unit 108 generates an operation plan for executing work in a range in which a constraint condition is satisfied with each of the one portable robot arm 20 and the two AGVs 40.

The control unit 107 controls a robot (for example, each of a portable robot arm 20, a mobile robot arm 30, and an AGV 40) included in the resources of the combination identified by the identification unit 105 (step S9). For example, the control unit 107 generates a control signal for controlling the robot based on the operation plan generated by the second generation unit 108. Also, the control unit 107 outputs the generated control signal to the robot.

The portable robot arm 20, the mobile robot arm 30, and the AGV 40 to be controlled by the processing device 10 execute a process according to control under the control of the processing device 10.

### Advantages

As described above, the processing system 1 according to the example embodiment of the present disclosure has been described. In the processing device 10 of the processing system 1, the first generation unit 104 generates a predictive model MDL for predicting a work time according to each combination of resources included in a plurality of resources based on task information INF1 including combinations of types of a plurality of tasks included in predetermined work and skills required for each of a plurality of tasks and resource information INF2 including combinations of types of a plurality of resources for executing the predetermined work, a quantity of each of the plurality of resources, and skills possessed by the plurality of resources. The identification unit 105 identifies a combination of resources included in a plurality of resources for completing predetermined work in the shortest work time based on the quantity of each of the plurality of tasks and the predictive model MDL.

Thereby, the processing device 10 can identify an appropriate resource for predetermined work.

In addition, the predictive model may further include information indicating a distribution of skills included in each of resources for each combination of the resources. Moreover, the information indicating the combination of resources may further include information indicating the distribution of skills for each of the resources. By taking such a configuration, the processing device 10 can clearly identify a skill required to be activated for each resource in addition to the resources.

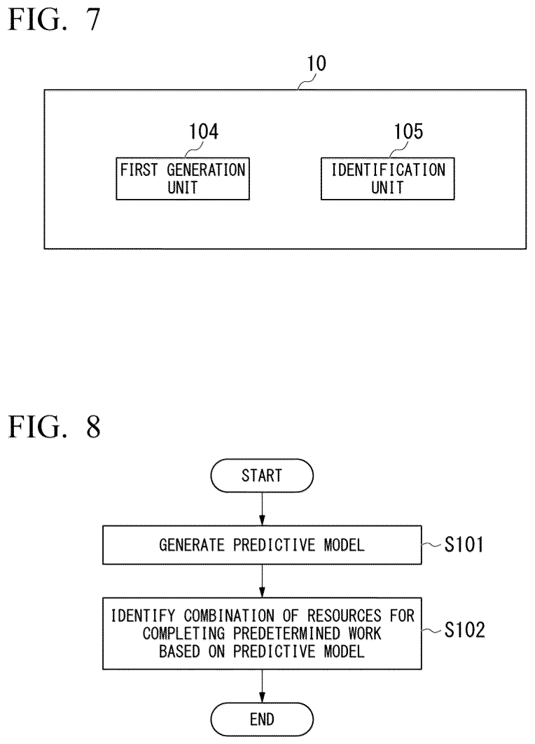

Next, a processing device 10 having a minimum configuration according to an example embodiment of the present disclosure will be described. FIG. 7 is a diagram showing an example of the processing device 10 having the minimum configuration according to the example embodiment of the present disclosure. As shown in FIG. 7, the processing device 10 having the minimum configuration includes a first generation unit 104 (an example of a first generation means) and an identification unit 105 (an example of an identification means). The first generation unit 104 generates a predictive model for predicting a work time according to each combination of resources included in a plurality of resources based on task information including combinations of types of a plurality of tasks included in predetermined work and skills required for each of a plurality of tasks and resource information including combinations of types of a plurality of resources for executing the predetermined work, a quantity of each of the plurality of resources, and skills possessed by the plurality of resources. The first generation unit 104 can be implemented, for example, using the functions of the first generation unit 104 exemplified in FIG. 2. The identification unit 105 identifies a combination of resources included in a plurality of resources for completing predetermined work in the shortest work time based on the quantity of each of the plurality of tasks and the predictive model generated by the first generation unit 104. The identification unit 105 can be implemented, for example, using the functions of the identification unit 105 exemplified in FIG. 2.

Next, a process of the processing device 10 having the minimum configuration will be described. FIG. 8 is a diagram showing an example of a processing flow of the processing device 10 having the minimum configuration according to the example embodiment of the present disclosure. Here, the process of the processing device 10 having the minimum configuration will be described with reference to FIG. 8.

The first generation unit 104 generates a predictive model for predicting a work time according to each combination of resources included in a plurality of resources based on task information including combinations of types of a plurality of tasks included in predetermined work and skills required for each of a plurality of tasks and resource information including combinations of types of a plurality of resources for executing the predetermined work, a quantity of each of the plurality of resources, and skills possessed by the plurality of resources (step S101). The identification unit 105 identifies a combination of resources included in a plurality of resources for completing predetermined work in the shortest work time based on the quantity of each of the plurality of tasks and the predictive model generated by the first generation unit 104 (step S102).

The processing system 1 having the minimum configuration according to the example embodiment of the present disclosure has been described above. The processing system 1 can identify an appropriate resource for predetermined work.

In addition, in a process according to each example embodiment of the present disclosure, the order of processing may be swapped in a range in which an appropriate process is performed.

Moreover, the process in each example embodiment of the present disclosure may be a combination of processes in the example embodiments in a range in which an appropriate process is performed.

Although example embodiments of the present disclosure have been described, the above-described processing system 1, the processing device 10, the input unit 101, the acquisition unit 103, the first generation unit 104, the identification unit 105, the allocation unit 106, the control unit 107, the second generation unit 108, the portable robot arm 20, the mobile robot arm 30, the AGV 40, and other processing devices may internally have a computer device. The process of the above-described processing is stored on a computer-readable recording medium in the form of a program, and the above process is performed by the computer reading and executing the program. A specific example of the computer is shown below.

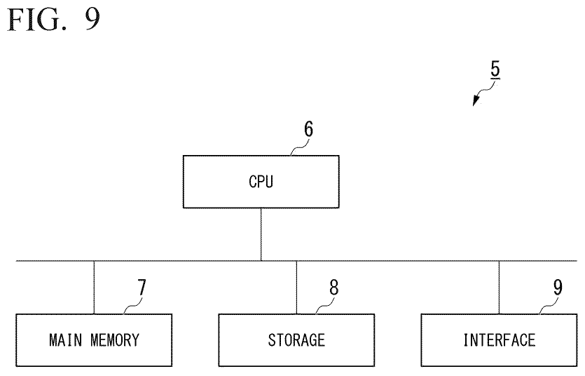

FIG. 9 is a schematic block diagram showing a configuration of a computer according to at least one example embodiment. As shown in FIG. 9, a computer 5 includes a central processing unit (CPU) 6, a main memory 7, a storage 8, and an interface 9. For example, each of the above-described processing system 1, the processing device 10, the input unit 101, the acquisition unit 103, the first generation unit 104, the identification unit 105, the allocation unit 106, the control unit 107, the second generation unit 108, the portable robot arm 20, the mobile robot arm 30, the AGV 40, and the other processing device is implemented in the computer 5. Also, the operation of each processing unit described above is stored in the storage 8 in the form of a program. The CPU 6 reads the program from the storage 8, loads the program into the main memory 7, and executes the above-described process in accordance with the program. Moreover, the CPU 6 secures a storage area corresponding to each of the above-described storage units in the main memory 7 in accordance with the program.

Examples of the storage 8 include a hard disk drive (HDD), a solid-state drive (SSD), a magnetic disk, a magneto-optical disk, a compact disc read-only memory (CD-ROM), a digital versatile disc read-only memory (DVD-ROM), a semiconductor memory, and the like. The storage 8 may be an internal medium directly connected to a bus of the computer 5 or an external medium connected to the computer 5 via the interface 9 or a communication line. Also, in a case where the above program is distributed to the computer 5 via a communication line, the computer 5 receiving the distributed program may load the program into the main memory 7 and execute the above process. In at least one example embodiment, the storage 8 is a non-transitory tangible storage medium.

Moreover, the program may be a program for implementing some of the above-mentioned functions. Furthermore, the program may be a file for implementing the above-described function in combination with another program already stored in the computer system, a so-called differential file (differential program).

Although several example embodiments of the present disclosure have been described, these example embodiments are examples and do not limit the scope of the present disclosure. In relation to these example embodiments, various additions, omissions, substitutions, and other modifications can be made without departing from the spirit or scope of the present disclosure.

Although some or all of the above-described example embodiments may also be described as in the following supplementary notes, the present disclosure is not limited to the following supplementary notes.

### (Supplementary Note 1)

A processing device including:
a first generation means configured to generate a predictive model for predicting a required work time of a task according to a combination of resources based on a combination of one or more types of tasks included in predetermined work and one or more skills required to execute the task, one or more types of resources for executing the predetermined work, a quantity of each of the resources, and a skill possessed by each of the resources; and
an identification means configured to identify the combination of the resources for completing the predetermined work based on the quantity of each of the tasks and the predictive model.

### (Supplementary Note 2)

The processing device according to supplementary note 2, including an allocation means configured to allocate the combination of the resources identified by the identification means to the predetermined work.

### (Supplementary Note 3)

The processing device according to supplementary note 2, including a second generation means configured to generate an operation plan that is a plan to be applied to an executable operation of the resources allocated by the allocation means.

### (Supplementary Note 4)

The processing device according to supplementary note 3,
wherein the resources include a robot, and
wherein the processing device includes a control means configured to control the robot included in the resources of the combination identified by the identification means based on the operation plan.

### (Supplementary Note 5)

The processing device according to any one of supplementary notes 1 to 4,
wherein the skill includes at least information indicating a feasible work quantity within a predetermined time.

### (Supplementary Note 6)

The processing device according to any one of supplementary notes 1 to 5,
wherein the predictive model further includes information indicating a distribution of the skills included in the resources, and
wherein the combination of the resources further includes information indicating the distribution.

### (Supplementary Note 7)

The processing device according to any one of supplementary notes 1 to 6,
wherein the resource further includes a condition for activating the skill,
wherein the skills further include a skill for achieving the condition, and
wherein the first generation means generates the predictive model based on the skill of the resource validated after the skill for achieving the condition is activated in a case where the condition is set for the resource.

### (Supplementary Note 8)

The processing device according to supplementary note 7,
wherein the condition involves relocation of the resource, and
wherein the skill for achieving the condition is the relocation of the resource matching a type of the resource.

### (Supplementary Note 9)

A processing system including:
the processing device according to any one of supplementary notes 1 to 8; and
a robot configured to execute a process in accordance with control of the processing device.

### (Supplementary Note 10)

A processing method including:
generating a predictive model for predicting a required work time of a task according to a combination of resources based on a combination of one or more types of tasks included in predetermined work and one or more skills required to execute the task, one or more types of resources for executing the predetermined work, a quantity of each of the resources, and a skill possessed by each of the resources; and
identifying the combination of the resources for completing the predetermined work based on the quantity of each of the tasks and the predictive model.

### (Supplementary Note 11)

A recording medium storing a program for causing a computer to:
generate a predictive model for predicting a required work time of a task according to a combination of resources based on a combination of one or more types of tasks included in predetermined work and one or more skills required to execute the task, one or more types of resources for executing the predetermined work, a quantity of each of the resources, and a skill possessed by each of the resources; and
identify the combination of the resources for completing the predetermined work based on the quantity of each of the tasks and the predictive model.

### INDUSTRIAL APPLICABILITY

According to each example aspect of the present disclosure, it is possible to identify an appropriate resource for a predetermined task.

### REFERENCE SIGNS LIST

1 Processing system
5 Computer
6 CPU
7 Main memory
8 Storage
9 Interface
10 Processing device
20, 20a, 20b Portable robot arm
30, 30a, 30b, 30c Mobile robot arm
40, 40a. 40b, 40c AGV
101 Input unit
102 Storage unit
103 Acquisition unit
104 First generation unit
105 Identification unit
106 Allocation unit
107 Control unit
108 Second generation unit

What is claimed is:

1. A calculator comprising:
a memory configured to store instructions; and
a processor configured to execute the instructions to:
generate a predictive model for predicting a required work time of a task according to a combination of resources based on a combination of one or more types of tasks included in predetermined work and one or more skills required to execute the task, one or more types of resources for executing the predetermined work, a quantity of each of the resources, and a skill possessed by each of the resources; and
identify the combination of the resources for completing the predetermined work based on the quantity of each of the tasks and the predictive model.

2. The calculator according to claim 1, wherein the processor allocates the combination of the resources to the predetermined work.

3. The calculator according to claim 2, wherein the processor generates an operation plan that is a plan to be applied to an executable operation of the resources.

4. The calculator according to claim 3,
wherein the resources include a robot, and
wherein the processor controls the robot included in the resources of the combination based on the operation plan.

5. The calculator according to claim 1, wherein the skill includes at least information indicating a feasible work quantity within a predetermined time.

6. The calculator according to claim 1,
wherein the predictive model further includes information indicating a distribution of the skills included in the resources, and
wherein the combination of the resources further includes information indicating the distribution.

7. The calculator according to claim 1,
wherein the resource further includes a condition for activating the skill,
wherein the skills further include a skill for achieving the condition, and
wherein the processor generates the predictive model based on the skill of the resource validated after the skill for achieving the condition is activated in a case where the condition is set for the resource.

8. The calculator according to claim 7,
wherein the condition involves relocation of the resource, and
wherein the skill for achieving the condition is the relocation of the resource matching a type of the resource.

9. A processing system comprising:
the calculator according to claim 1; and
a robot configured to execute a process in accordance with control of the calculator.

10. A processing method comprising:
generating a predictive model for predicting a required work time of a task according to a combination of resources based on a combination of one or more types of tasks included in predetermined work and one or more skills required to execute the task, one or more types of resources for executing the predetermined work, a quantity of each of the resources, and a skill possessed by each of the resources; and
identifying the combination of the resources for completing the predetermined work based on the quantity of each of the tasks and the predictive model.

11. A non-transitory recording medium storing a program for causing a computer to:
generate a predictive model for predicting a required work time of a task according to a combination of resources based on a combination of one or more types of tasks included in predetermined work and one or more skills required to execute the task, one or more types of resources for executing the predetermined work, a quantity of each of the resources, and a skill possessed by each of the resources; and
identify the combination of the resources for completing the predetermined work based on the quantity of each of the tasks and the predictive model.
